(19) United States
(12) Patent Application Publication
(10) Pub. No.: US 2009/0132960 A1
(43) Pub. Date: May 21, 2009

(54) TERMINAL, METHOD OF CONTROLLING THE SAME AND RECORDING MEDIUM FOR THE METHOD

(75) Inventor: Min Seok Park, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/245,383

(22) Filed: Oct. 3, 2008

(30) Foreign Application Priority Data
Nov. 21, 2007 (KR) 10-2007-0119292

(51) Int. Cl. G06F 3/048

(52) U.S. Cl. 715/810

(57) ABSTRACT

A terminal includes a display unit, a storage unit storing objects corresponding to at least one of a plurality of object categories, and a control unit displaying one or more higher priority objects selected from a plurality of objects according to a priority of each of the plurality of object categories, on a screen of the display unit.

### CROSS-REFERENCE TO RELATED APPLICATIONS

This application claims the benefit of the Korean Patent Application No. 10-2007-0119292, filed on 21 Nov. 2007, which is hereby incorporated by reference as if fully set forth herein.

### FIELD OF THE INVENTION

The present invention relates to a terminal, method of controlling the same and recording medium for the method. Although the present invention is suitable for a wide scope of applications, it is particularly suitable for facilitating a user to display various objects on a display screen of the terminal.

### DISCUSSION OF THE RELATED ART

A mobile terminal may be configured to perform various functions. Examples of such functions include data and voice communications, capturing images and video via a camera, recording audio, playing music files via a speaker system, and displaying images and video on a display. Some terminals further support games and multimedia. More recently, mobile terminals have been configured to receive broadcast and multicast signals which permit viewing of contents such as videos and television programs.

Efforts are ongoing to support and increase the functionality of mobile terminals. Such efforts include software and hardware improvements, as well as changes and improvements in the structural components which form the mobile terminal.

As mentioned above, the terminal capable of performing various functions displays various objects on the display screen, the various objects corresponding to the various functions. The object is defined as a terminology to commonly or collectively refer to a phone number, a multimedia file, or a message which are related to various functions, such as a phone call, messaging, multimedia, and video.

The objects are diversified as the terminal use increases. Therefore, it is necessary for a terminal user to configure the terminal to distinguish and select the objects easily when the diversified objects are displayed on the display screen.

### SUMMARY OF THE INVENTION

Accordingly, the present invention is directed to a terminal, method of controlling the same and recording medium for the method that substantially obviate one or more problems due to limitations and disadvantages of the related art.

In an embodiment of the present invention, a terminal includes a display unit, a storage unit storing objects corresponding to at least one object category among a plurality of object categories, and a control unit displaying one or more higher priority objects selected from a plurality of objects according to a priority of each of the plurality of object categories on a screen of the display unit. Preferably, the control unit aligns the one or more higher priority objects in different directions according to corresponding categories to which the one or more higher priority objects belong.

Preferably, the control unit further displays the one or more higher priority objects such that figures of the one or more higher priority objects are visually distinguished from each other according to the corresponding categories. Preferably, the control unit associates an appearance of the one or more higher priority objects with a direction of a category to which the one or more higher priority objects belong.

In one aspect of the present, invention, the display unit inculdes a touchscreen and the one or more higher priority objects belonging to a prescribed category are aligned on the touchscreen such that the control unit displays lower priority objects among the one or more higher priority objects on the touchscreen if the touchscreen is scrolled in a first direction. Preferably, the control unit scrolls the touchscreen if the touchscreen is touched and flicked. Preferably, the control unit executes a flicked object if the one or more higher priority objects belonging to the prescribed category on the touchscreen is flicked in a second direction substantially vertical to the first direction.

In another aspect of the present invention, the control unit associates a single object corresponding to at least two object categories with only one of the at least two object categories. The plurality of object categories includes at least one of a recent call number category, a recent stored number category, a recently absent number category, a most frequently call number category, a recent message category, a recently executed multimedia contents category, a most frequently executed multimedia contents category or a recently stored multimedia contents category.

In yet another aspect of the present invention, the control unit aligns the one or more higher priority objects in a 3-dimensional space. Preferably, the control unit aligns the one or more higher priority objects belonging to the object categories in specific directions associated with corresponding object categories. Preferably, the control unit locates the one or more higher priority objects belonging to the corresponding at least one object category at a central part of the screen of the display unit and the control unit locates the one or more objects in a peripheral part of the screen of the display unit if priorities of the one or more objects become lower.

In another embodiment of the present invention, a method of controlling a terminal includes storing objects corresponding to at least one of a plurality of object categories and displaying at least one of a plurality of objects according to a priority of each of the plurality of object categories such that one or more higher priority objects are displayed on a display screen of the terminal.

The method of claim 13, wherein the plurality of object categories comprise at least one of a recent call number category, a recent stored number category, a recently absent number category, a most frequently call number category, a recent message category, a recently executed multimedia contents category, a most frequently executed multimedia contents category or a recently stored multimedia contents category. Preferably, the at least one higher priority objects are aligned in different directions according to corresponding object categories to which the at least one higher priority objects belong.

In one aspect of the present invention, the at least one higher priority objects belonging to a plurality of corresponding object categories are aligned in specific directions associated with the plurality of corresponding object categories. Preferably, the at least one higher priority objects are aligned in a 3-dimensional space.

In yet another embodiment of the present invention, a recording medium including a recorded program is provided, the program executing a method of controlling a terminal. The method includes storing objects corresponding to at least one of a plurality of object categories and displaying at least one or more of a plurality of the objects according to a priority for each of the plurality of object categories such that at least one higher priority objects displayed on a display screen of the terminal.

It is to be understood that both the foregoing general description and the following detailed description of the preferred embodiment of the present invention are exemplary and explanatory and are intended to provide further explanation of the invention as claimed.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIG. 1 is a block diagram of a mobile terminal in accordance with an embodiment of the present invention.

FIG. 2 is a perspective view of a front side of a mobile terminal according to an embodiment of the present invention.

FIG. 3 is a rear view of the mobile terminal shown in FIG. 2.

FIG. 4 is a block diagram of a CDMA wireless communication system operable with the mobile terminal of FIGS. 1-3.

FIG. 5 is a flowchart illustrating a method of controlling a mobile terminal according to an embodiment of the present invention.

FIG. 6 is a diagram illustrating objects displayed on a virtual display screen and a real display screen in accordance with a predetermined pattern in a mobile terminal according to the present invention.

FIG. 7 is a diagram illustrating the objects shown in FIG. 6.

FIG. 8 is a diagram illustrating a state of a display screen for implementing a method of controlling a mobile terminal according to an embodiment of the present invention.

FIG. 9 is a diagram illustrating a state of a display screen for implementing a method of controlling a mobile terminal according to another embodiment of the present invention.

FIG. 10 is a diagram illustrating objects displayed on a virtual display screen and a real display screen in accordance with a predetermined pattern in a mobile terminal according to an embodiment of the present invention.

FIG. 11 is a diagram illustrating objects displayed on a virtual display screen and a real display screen in accordance with a predetermined pattern in a mobile terminal according to an embodiment of the present invention.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

In the following description, suffixes ‘module’, ‘unit’ and ‘part’ for elements are given to facilitate the preparation of this disclosure only. Therefore, significant meanings or roles are not given to the suffixes themselves. Hence, it is understood that the ‘module’, ‘unit’ and ‘part’ can be used together.

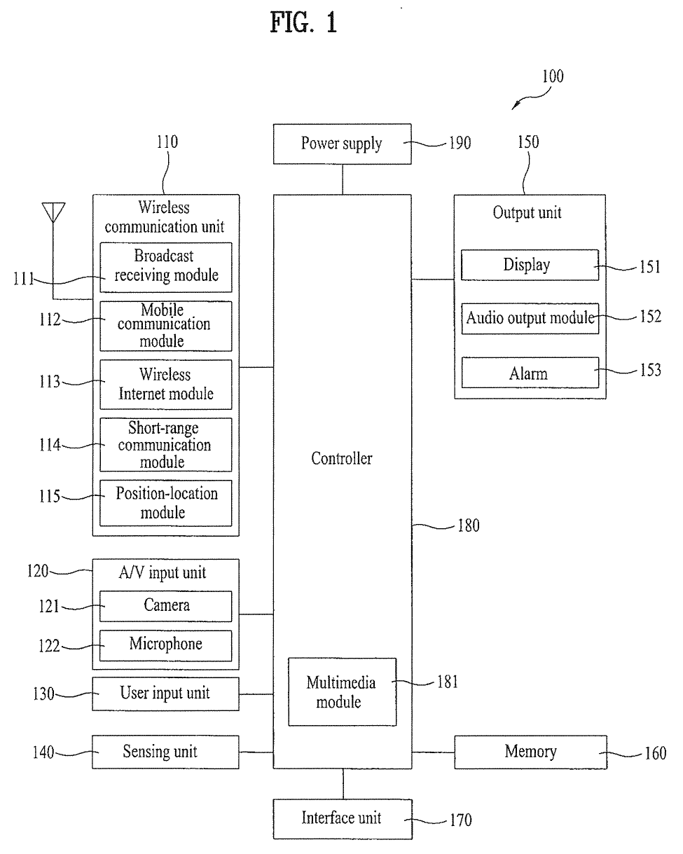

FIG. 1 is a block diagram of mobile terminal 100 in accordance with an embodiment of the present invention. The mobile terminal 100 may be implemented using a variety of different types of terminals. Examples of such terminals include mobile phones, user equipment, smart phones, computers, digital broadcast terminals, personal digital assistants, portable multimedia players (PMP) and navigators.

By way of non-limiting example only, further description will be with regard to a mobile terminal 100. However, such teachings apply equally to other types of terminals, FIG. 1 shows the mobile terminal 100 having various components, but it is understood that implementing all of the illustrated components is not a requirement. Greater or fewer components may alternatively be implemented.

FIG. 1 shows a wireless communication unit 110 configured with several commonly implemented components. For example, the wireless communication unit 110 typically includes one or more components which permit wireless communication between the mobile terminal 100 and a wireless communication system or network within which the mobile terminal is located.

The broadcast receiving module 111 receives a broadcast signal and/or broadcast associated information from an external broadcast managing entity via a broadcast channel. The broadcast channel may include a satellite channel or a terrestrial channel. The broadcast managing entity refers generally to a system which transmits a broadcast signal and/or broadcast associated information. Examples of broadcast associated information include information associated with a broadcast channel, a broadcast program, and a broadcast service provider. For example, the broadcast associated information may include an electronic program guide (EPG) of digital multimedia broadcasting (DMB) and electronic service guide (ESG) of digital video broadcast-handheld (DVB-H).

The broadcast signal may be implemented, for example, as a TV broadcast signal, a radio broadcast signal, or a data broadcast signal. The broadcast signal may further include a broadcast signal combined with a TV or radio broadcast signal.

The broadcast receiving module 111 may be configured to receive broadcast signals transmitted from various types of broadcast systems. By way of non-limiting examples, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receiving multicast signals is also possible. Data received by the broadcast receiving module 111 may be stored in a suitable device, such as the memory 160.

The mobile communication module 112 communicates wireless signals with one or more network entities, such as base station or Node-B. Such signals may represent, for example, audio, video, multimedia, control signaling, or data.

The wireless Internet module 113 supports Internet access for the mobile terminal 100. The wireless Internet module 113 may be internally or externally coupled to the mobile terminal 100.

The short-range communication module 114 facilitates relatively short-range communications. Suitable technologies for short-range communication may include, but are not limited to, radio frequency identification (RFID), infrared data association (IrDA), ultra-wideband (UWB), as well at the networking technologies commonly referred to as BLUETOOTH® and ZIGBEE®.

The position-location module 115 identifies or otherwise obtains the location of the mobile terminal 100. The position-location module 115 may be implemented using global positioning system (GPS) components which cooperate with associated satellites, network components, and combinations thereof.

The audio/video (A/V) input unit 120 is configured to provide audio or video signal input to the mobile terminal 100. As shown, the A/V input unit 120 includes a camera 121 and a microphone 122.

The camera 121 receives and processes image frames of still pictures or video. The microphone 122 receives an external audio signal while the mobile terminal 100 is in a particular mode, such as phone call mode, recording mode and voice recognition. This audio signal is processed and converted into digital data. The mobile terminal 100, and specifically the A/V input unit 120, may include assorted noise removing algorithms to remove noise generated in the course of receiving the external audio signal. Data generated by the A/V input unit 120 may be stored in the memory 160, utilized by the output unit 150, or transmitted via one or more modules of the communication unit 110. If desired, two or more microphones and/or cameras may be used.

The user input unit 130 generates input data responsive to user manipulation of an associated input device or devices. Examples of such devices include a keypad, a dome switch, a touchpad such as static pressure/capacitance, a jog wheel and a jog switch. A specific example is one in which the user input unit 130 is configured as a touchpad in cooperation with a touchscreen display, which will be described in more detail later.

The sensing unit 140 provides status measurements of various aspects of the mobile terminal 100. For example, the sensing unit 140 may detect an open/close status of the mobile terminal 100, the relative positioning of components such as a display and keypad, a change of position of the mobile terminal or a component of the mobile terminal, a presence or absence of user contact with the mobile terminal, orientation or acceleration/deceleration of the mobile terminal.

The mobile terminal 100 may be configured as a slide-type mobile terminal and the sensing unit 140 may sense whether a sliding portion of the mobile terminal is open or closed. The sensing unit 140 may also sense the presence or absence of power provided by the power supply 190, the presence or absence of a coupling or other connection between the interface unit 170 and an external device.

The interface unit 170 may be implemented to couple the mobile terminal 100 with external devices. Typical external devices include wired/wireless headphones, external chargers, power supplies, storage devices configured to store data such as audio, video, and pictures, earphones, and microphones. The interface unit 170 may be configured using a wired/wireless data port, audio input/output ports, video input/output ports, or a card socket for coupling to a memory card, subscriber identity module (SIM) card, user identity module (UIM) card, or a removable user identity module (RUIM) card.

The output unit 150 may include various components that support the output requirements of the mobile terminal 100. The display 151 may be implemented to visually display information associated with the mobile terminal 100. The display 151 may provide a user interface or graphical user interface that includes information associated with placing, conducting, and terminating a phone call if the mobile terminal 100 is operating in a phone call mode. As another example, the display 151 may additionally or alternatively display images which are associated with a video call mode or a photographing mode.

One particular implementation of the present invention includes the display 151 configured as a touch screen working in cooperation with an input device, such as a touchpad. This configuration permits the display 151 to function both as an output device and an input device.

The display 151 may be implemented using known display technologies including a liquid crystal display (LCD), a thin film transistor-liquid crystal display (TFT-LCD), an organic light-emitting diode display (OLED), a flexible display and a three-dimensional display. The mobile terminal 100 may include one or more displays 151. An example of a two-display embodiment is one in which one display 151 is configured as an internal display viewable when the terminal is in an opened position and a second display 151 configured as an external display viewable in both the open and closed positions.

FIG. 1 further shows the output unit 150 having an audio output module 152, which supports the audio output requirements of the mobile terminal 100. The audio output module 152 may be implemented using one or more speakers, buzzers, other audio producing devices, or combinations thereof.

The audio output module 152 functions in various modes such as call-receiving mode, call-placing mode, recording mode, voice recognition mode and broadcast reception mode. The audio output module 152 outputs audio relating to a particular function or status, such as call received, message received, or errors.

The output unit 150 is further shown having an alarm 153, which may signal or otherwise identify the occurrence of a particular event associated with the mobile terminal 100. Typical events include call received, message received and user input received.

An example of a signal provided by the output unit 150 is a tactile sensation. For example, the alarm 153 may be configured to vibrate responsive to the mobile terminal 100 receiving a call or message. As another example, vibration may be provided by the alarm 153 responsive to receiving user input at the mobile terminal 100 in order to provide a tactile feedback mechanism. It is understood that the various signals provided by the components of output unit 150 may be separately performed, or performed using any combination of such components.

The memory 160 is generally used to store various types of data to support the processing, control, and storage requirements of the mobile terminal 100. Examples of such data include program instructions for applications operating in the mobile terminal 100, contact data, phonebook data, messages, pictures, and video.

The memory 160 shown in FIG. 1 may be implemented using any type or combination of suitable volatile and non-volatile memory or storage devices. Examples of memory types are random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk memory, card-type memory, and other similar memory or data storage devices.

The controller 180 typically controls the overall operations of the mobile terminal 100. For example, the controller 180 performs the control and processing associated with voice calls, data communications, instant message communication, video calls, camera operations and recording operations.

The controller 180 may include a multimedia module 181 that provides multimedia playback. The multimedia module 181 may be configured as part of the controller 180, or implemented as a separate component.

The power supply 190 provides power required by the various components for the mobile terminal 100. The power may be internal power, external power, or combinations thereof.

Various embodiments described herein may be implemented in various ways. For example, the embodiments may be implemented in a computer-readable medium using computer software, hardware, or some combination thereof.

For a hardware implementation, the embodiments described may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory, such as the memory 160, and executed by a controller or processor, such as the controller 180.

The mobile terminal 100 may be implemented in a variety of different configurations. Examples of such configurations include folder-type, slide-type, bar-type, rotational-type, swing-type and combinations thereof. For clarity, further disclosure will primarily relate to a slide-type mobile terminal 100. However, such teachings apply equally to other types of mobile terminals 100.

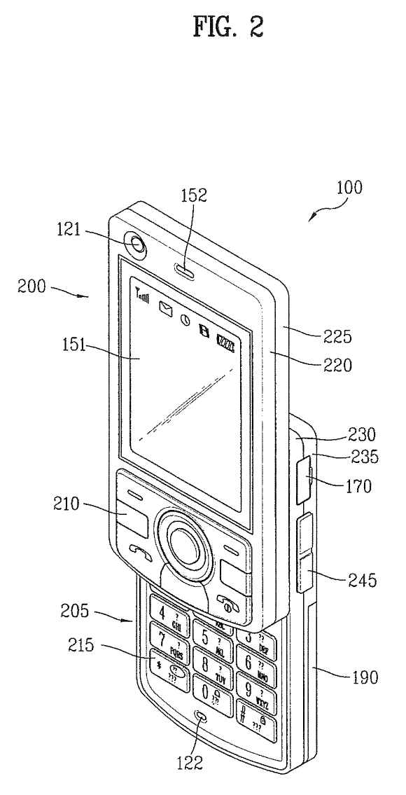

FIG. 2 is a perspective view of a front side of a mobile terminal 100 according to an embodiment of the present invention. In FIG. 2, the mobile terminal 100 is shown having a first body 200 configured to slidably cooperate with a second body 205.

The user input unit 130 (described in FIG. 1) is implemented using function keys 210 and a keypad 215. The function keys 210 are located on the first body 200 and the keypad 215 is located on the second body 205. The keypad 215 includes various keys, such as numbers, characters, and symbols to enable a user to place a call, prepare a text or multimedia message, and otherwise operate the mobile terminal 100.

The first body 200 slides relative to the second body 205 between open and closed positions. The first body 200 is positioned over the second body 205 in the closed position such that the keypad 215 is substantially or completely obscured by the first body. User access to the keypad 215, the display 151 and the function keys 210 is facilitated in the open position. The function keys 210 are conveniently configured for a user to enter commands, such as start, stop and scroll.

The mobile terminal 100 is operable in either a standby mode or an active call mode. The mobile terminal 100 is able to receive a call or message and to receive and respond to network control signaling in the standby mode.

The mobile terminal 100 typically operates in the standby mode in the closed position and in the active mode in the open position. This mode configuration may be changed as required or desired.

The first body 200 is shown formed of a first case 220 and a second case 225. The second body 205 is shown formed of a first case 230 and a second case 235. The front case 220 and second case 225 of the first body 200 and the first case 230 and second case 235 or the second body 205 are usually formed of a suitably rigid material, such as injection molded plastic, or formed using metallic material, such as stainless steel (STS) and titanium (Ti).

One or more intermediate cases may be provided between the first case 220 and second case 225 of the first body 200 or between the first case 230 and second case 235 of the second body 205. The first body 200 and second body 205 are typically sized to receive electronic components necessary to support operation of the mobile terminal 100.

The first body 200 is shown having a camera 121 and audio output module 152, which is configured as a speaker, positioned relative to the display 151. The camera 121 may be constructed such that it can be selectively positioned relative to first body 200, such as by rotation or swiveling.

The function keys 210 are positioned adjacent to a lower side of the display 151, which is shown implemented as an LCD or OLED. The display 151 may also be configured as a touch screen having an underlying touchpad which generates signals responsive to user contact with the touch screen, such as with a finger or stylus.

The second body 205 is shown having a microphone 122 positioned adjacent to the keypad 215 and having side keys 245, which are one type of user input unit, positioned along the side of second body. Preferably, the side keys 245 are configured as hot keys, such that the side keys are associated with a particular function of the mobile terminal 100.

An interface unit 170 is shown positioned adjacent to the side keys 245. A power supply 190 in a form of a battery is shown located on a lower portion of the second body 205.

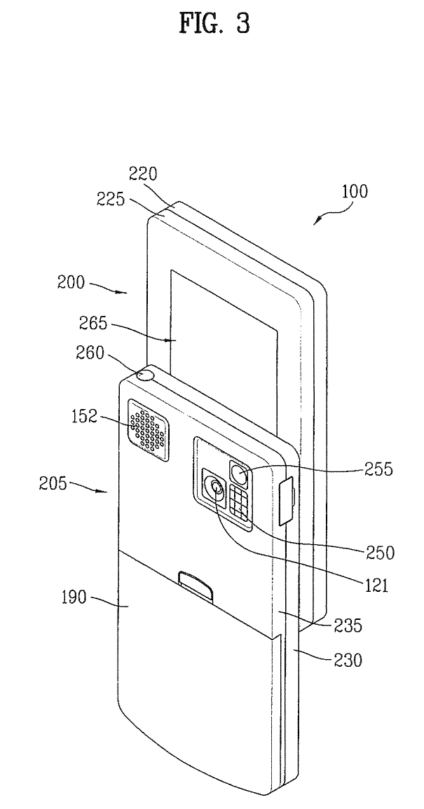

FIG. 3 is a rear view of the mobile terminal shown in FIG. 2. FIG. 3 shows the second body 205 having a camera 121 with an associated flash 250 and mirror 255. The flash 250 operates in conjunction with the camera 121. The mirror 255 is useful for assisting a user to position the camera 121 in a self-portrait mode.

The camera 121 of the second body 205 illustrated in FIG. 3 faces a direction opposite to a direction faced by the camera 121 of the first body 200 illustrated in FIG. 2. Each of the cameras 121 of the first body 200 and second body 205 may have the same or different capabilities.

The camera 121 of the first body 200 in one embodiment operates with a relatively lower resolution than the camera 121 of the second body 205. Such an arrangement works well during a video conference, for example, in which reverse link bandwidth capabilities may be limited. The relatively higher resolution of the camera 121 of the second body 205 is useful for obtaining higher quality pictures for later use or for communicating with other parties.

The second body 205 illustrated in FIG. 3 also includes an audio output module 152 located on an upper side of the second body and configured as a speaker. The audio output modules 152 of the first body 200 and second body 205 may cooperate to provide stereo output. Moreover, either or both of these audio output modules 152 may be configured to operate as a speakerphone.

A broadcast signal receiving antenna 260 is shown located at an upper end of the second body 205 in FIG. 3. The antenna 260 functions in cooperation with the broadcast receiving module 111 illustrated in FIG. 1. The antenna 260 may be fixed or retractable into the second body 205.

The rear side of the first body 200 includes a slide module 265. The slide module 265 slidably couples with a corresponding slide module located on the front side of the second body 205.

It is understood that the arrangement of the various components of the first body 200 and second body 205 illustrated in FIGS. 2 and 3 may be modified as required or desired. For example, some or all of the components of one body may alternatively be implemented on the other body. Further, the location and relative positioning of the components are not critical and, therefore, the components may be positioned at locations which differ from those shown in FIGS. 2 and 3.

The mobile terminal 100 of FIGS. 1-3 may be configured to operate within a communication system which transmits data via frames or packets, including both wireless and wired communication systems and satellite-based communication systems. Such communication systems utilize different air interfaces and/or physical layers.

Examples of air interfaces utilized by the communication systems include frequency division multiple access (FDMA), time division multiple access (TDMA), code division multiple access (CDMA), the universal mobile telecommunications system (UMTS), the long term evolution (LTE) of the UMTS, and the global system for mobile communications (GSM). By way of non-limiting example only, further description will relate to a CDMA communication system, but such teachings apply equally to other system types.

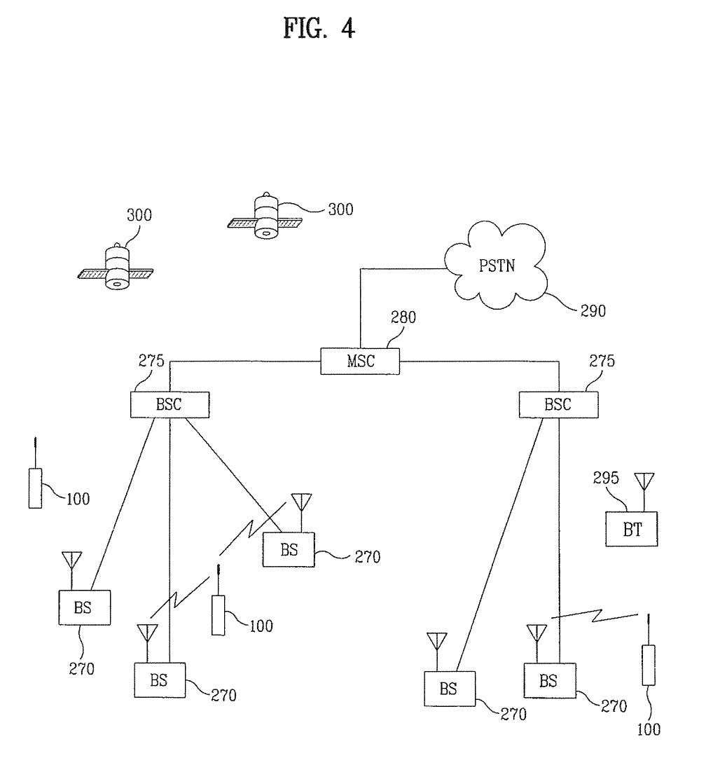

Referring to FIG. 4, a CDMA wireless communication system is shown having a plurality of mobile terminals 100, a plurality of base stations (BS) 270, a plurality of base station controllers (BSC) 275, and a mobile switching center (MSC) 280.

The MSC 280 is configured to interface with a conventional public switch telephone network (PSTN) 290. The MSC 280 is also configured to interface with the BSCs 275.

The BSCs 275 are coupled to the base stations 270 via backhaul lines. The backhaul lines may be configured in accordance with any of several known interfaces including E1/T1, ATM, IP, PPP, Frame Relay, HDSL, ADSL, or xDSL. It is to be understood that the system may include more than two BSCs 275.

Each BS 270 may include one or more sectors, each sector having an omni-directional antenna or an antenna pointed in a particular direction radially away from the base station. Alternatively, each sector may include two antennas for diversity reception. Each BS 270 may be configured to support a plurality of frequency assignments each having a particular spectrum, such as 1.25 MHz or 5 MHz.

The intersection of a sector and frequency assignment may be referred to as a CDMA channel. The BSs 270 may also be referred to as base station transceiver subsystems (BTSs).

The term “base station” may be used to refer collectively to a BSC 275 and one or more BSs 270. The BSs 270 may also be denoted as “cell sites.” Alternatively, individual sectors of a given BS 270 may be referred to as “cell sites.”

A terrestrial digital multimedia broadcasting (DMB) transmitter (BT) 295 is shown broadcasting to the mobile terminals 100 operating within the system. The broadcast receiving module 111 illustrated in FIG. 1 may be configured to receive broadcast signals transmitted by the BT 295. Similar arrangements may be implemented for other types of broadcast and multicast signaling as discussed above.

FIG. 4 further depicts several global positioning system (GPS) satellites 300 that facilitate locating the position of some or all of the mobile terminals 100. Two satellites 300 are depicted, but it is understood that useful positioning information may be obtained with greater or fewer satellites.

The position-location module 115 illustrated in FIG. 1 may be configured to cooperate with the satellites 300 to obtain desired position information. It is to be appreciated that other types of position detection technology may alternatively be implemented, such as location technology that may be used in addition to or instead of GPS location technology. If desired, some or all of the GPS satellites 300 may alternatively or additionally be configured to provide satellite DMB transmissions.

During typical operation of the wireless communication system, the BSs 270 receive sets of reverse-link signals from various mobile terminals 100. The mobile terminals 100 perform calls, messaging, and other communications.

Each reverse-link signal received by a given BS 270 is processed within that BS. The resulting data is forwarded to an associated BSC 275.

The BSC 275 provides call resource allocation and mobility management functionality including soft handoffs between the BSs 270. The BSCs 275 also route the received data to the MSC 280, which provides additional routing services for interfacing with the PSTN 290.

Similarly, the PSTN 290 interfaces with the MSC 280, which interfaces with the BSCs 275. The BSCs 275 control the BSs 270 to transmit sets of forward-link signals to the mobile terminals 100.

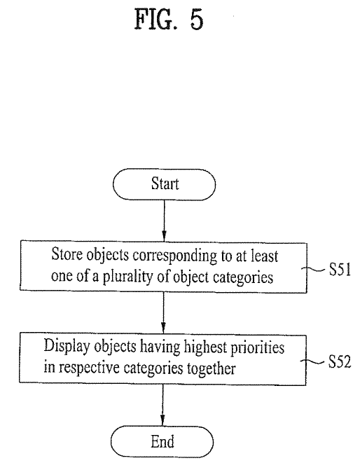

An embodiment of the present invention will be explained with reference to FIGS. 5 to 7. Objects can be classified into various object categories in accordance with their attributes. The various object categories may include a phone number category, a multimedia contents category such as moving picture file category, still picture file category, and music file category, and a message category. These categories are merely exemplary and more categories may be provided as the object categories.

Each of the categories may include at least one or more subcategories. It is to be understood that subcategories can be classified into categories on the same layer of their parental categories.

For example, the phone number category may include a recent call number category, a recently stored number category, a recently absent number category, and a frequent call number category such as a most frequently called number category and a most frequently calling number category.

The multimedia contents category may include subcategories such as a recently executed multimedia contents category, a most frequently executed multimedia contents category, and a recently stored multimedia contents category.

The message category may include subcategories such as a transmitted/received message category and a recent message category.

The objects are not necessarily configured to belong to only a single category, but the objects may be configured to belong to a plurality of categories. For example, a prescribed multimedia contents object may belong to both a most frequently executed multimedia contents category and a recently executed multimedia contents category.

Referring to FIG. 5, the objects are created and then stored in the memory 160 (S51). Thereafter, the objects are displayed on the display screen 151 of the mobile terminal 100 to facilitate a terminal user's convenience (S52).

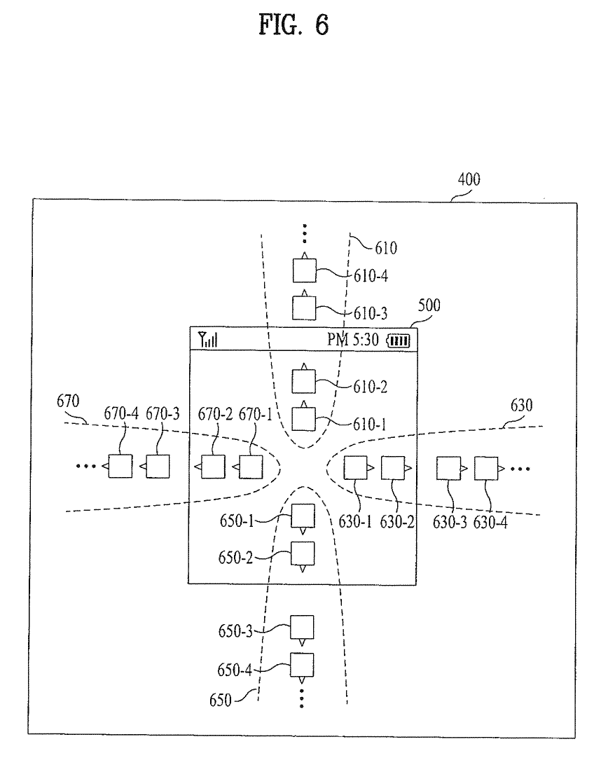

Referring to FIG. 6, the objects are displayed on a virtual display screen 400 and a real display screen 500 in accordance with a predetermined pattern in the mobile terminal 100. A concept of the virtual display screen 400 is used to help understanding of the present invention. However, it is to be understood that the virtual display screen 400 is not actually visible to a terminal user.

The controller 180 of the mobile terminal 100 configures the virtual display screen 400 using the memory 160. Although the virtual display screen 400 shown in FIG. 6 has a predetermined size due to a limited space, the virtual display screen may be conceptually realized to have an infinite size.

The objects are aligned on the virtual display screen 400 in a predetermined pattern and a plurality of object categories may be arranged. For example, in FIG. 6, four object categories, including a first object category 610, a second object category 630, a third object category 650 and a fourth object category 670, are aligned on the virtual display screen 400. Any categories may be selected from the object categories 610, 630, 650 and 670.

Referring to FIG. 6, the object categories 610, 630, 650 and 670 are displayed in a pattern such that they outwardly radiate from a center of the virtual display screen 400 in predetermined directions differing from each other. Specifically, the first object category 610 is displayed in a pattern such that it radiates from the center of the virtual display screen 400 in an upward direction. The second object category 630 is displayed in a pattern such that it radiates from the center of the virtual display screen 400 in a rightward direction. The third object category 650 is displayed in a pattern such that it radiates from the center of the virtual display screen 400 in a downward direction. And, the fourth object category 670 is displayed in a pattern such that it radiates from the center of the virtual display screen 400 in a leftward direction.

Sequence for mutually aligning the objects belonging to each of the object categories will be explained by referring to the first object category 610 as an example. For clarity and convenience of the following description, it is assumed that the first object category 610 is a phone number category.

A plurality of phone number objects 610-1, 610-2, 610-3, 610-4 belong to the phone number category 610. The plurality of phone number objects can be sequenced by a prescribed reference. For example, the reference may include a recently stored sequence, a recently used sequence, a most frequently used sequence or the like. A priority may be assigned to each of the plurality of phone number objects and the plurality of the phone number objects may be aligned according to their respective priorities.

A phone number object having a higher priority is aligned closer to the center of the virtual display screen 400, while a phone number object having a lower priority is aligned closer to the boundary of the virtual display screen. For example, a phone number object 610-1 having the highest priority in the phone number category 610 is aligned at the center of the virtual display screen 400 as shown in FIG. 6 while other phone number objects 610-2, 610-3, and 610-4 are aligned outwardly radiating according to their respective priorities in the sequence.

The above described alignment configuration of the objects is similarly applied to each of the second to fourth object categories 630, 650 and 670. An object 630-1/650-1/670-1 having a highest priority in each of the object categories is aligned at the center of the virtual display screen 400 and the rest of the objects 630-2/650-2/670-2, 630-3/650-3/670-3, . . . are aligned outwardly radiating according to their respective priorities in sequence.

Hence, the object having the highest priority in each of the first to fourth object categories is aligned at the center of the virtual display screen 400 (S52 in FIG. 5). A portion of the above-configured virtual display screen 400 is implemented with the real display screen 500, as shown in FIG. 6.

A portion of the virtual display screen 400 may be configured to appear on the real display screen 500 when the mobile terminal 100 is in a standby mode. Alternatively, a portion of the virtual display screen 400 can be configured to appear on the real display screen 500 if a prescribed menu manipulation is carried out by a terminal user.

A central portion of the virtual display screen can be configured to be displayed on the real display screen if the controller 180 commands a portion of the virtual display screen 400 to appear on the real display screen 500, the mobile terminal 100 enters the standby mode, or the prescribed menu manipulation is carried out, as shown in FIG. 6.

Referring to FIG. 6, the object having the highest priority, for example 610-1, and the object having a second highest priority, for example 610-2, in each of the object categories are displayed on the real display screen 500. In FIG. 6, four object categories 610-1, 610-2, 610-3, 610-4 are shown and the object having the highest priority 610-1, 630-1, 650-1, and 670-1 and the object having a second highest priority 610-2, 630-2, 650-2, and 670-2 in each of the object categories are displayed on the real display screen 500, and thus, a total of eight objects are displayed on the real display screen.

Therefore, a single object having a highest priority in each of the object categories or at least three objects having higher priorities in each of the object categories can be displayed on the real display screen 500. In other words, at least one object having the highest priority among a plurality of the objects in each of the categories is aligned and displayed according to category in one direction on the real display screen 500.

The objects that are not displayed on the real display screen 500 and exist in the virtual display screen 400 may be displayed on the real display screen 500 if a position of the real display screen is moved to another position from the center of the virtual display screen by terminal user's manipulation. This will be explained in detail later.

As mentioned in the foregoing description, the objects are not required to be configured to belong to a single category. The objects may be configured to belong to a plurality of categories as well. For example, a prescribed multimedia contents object may simultaneously belong to both a recently executed multimedia contents category and a most frequently executed multimedia contents category.

If both the recently executed multimedia contents category and the most frequently executed multimedia contents category are simultaneously aligned on the display screen, it is possible to configure the multimedia contents object belonging to both categories to be aligned to and displayed in only one of the two categories. The category in which the multimedia contents object is displayed may be determined by a priority of the multimedia contents object in each of the categories.

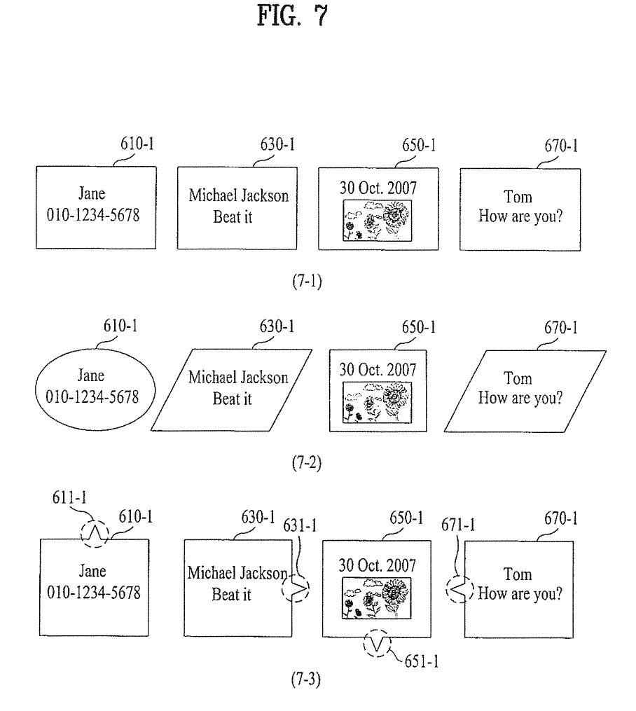

The appearance of the objects displayed on the virtual display screen 400 and real display screen 500 is explained with reference to FIG. 7. In the following description, it is assumed that the first to fourth object categories 610, 630, 650 and 670 correspond to a phone number category, a music file category, an image category and a message category, respectively. Respective objects belonging to the four object categories are shown in FIG. 7.

Referring to (7-1) of FIG. 7, figures of the objects may have the same shape regardless of the category to which the objects belong. Specifically, in (7-1) of FIG. 7, the four objects 610-1, 630-1, 650-1 and 670-1 belonging to four different object categories have the same rectangle shape.

Referring to (7-2) of FIG. 7, figures of the objects may be configured to have different shapes in accordance with the categories to which the objects belong. Specifically, in (7-2) of FIG. 7, the four objects 610-1, 630-1, 650-1 and 670-1 belonging to the four different object categories have different shapes. Even if the shapes of the objects are identical to each other, for example 630-1 and 670-1, these objects may be configured to have different colors to distinguish between them.

Referring to (7-3) of FIG. 7, the objects may be configured to have direction marks 611-1, 631-1, 651-1 and 671-1, which indicate radiation directions of the objects 610-1, 630-1, 650-1 and 670-1 in the virtual display screen 400 and real display screen 500. The direction marks are provided to the objects in accordance with respective categories to which the objects belong. The direction mark may be implemented in any shape as long as it can point to a corresponding direction. Further, each of the objects may be configured to indicate or imply a direction corresponding to the category to which the object belongs.

For example, in (7-3) of FIG. 7, the direction marks 611-1, 631-1, 651-1 and 671-1 are configured to be included in the objects 610-1, 630-1, 650-1 and 670-1 shown in (7-1) of FIG. 7. Alternatively, the direction marks may be configured such that they are included in the objects 610-1, 630-1, 650-1 and 670-1 shown in (7-2) of FIG. 7.

Thus, when the objects are displayed according to the corresponding category on the real display screen 500, one of the objects is selected and then executed. Execution of the object is described according to whether the display 151 includes a touchscreen or not.

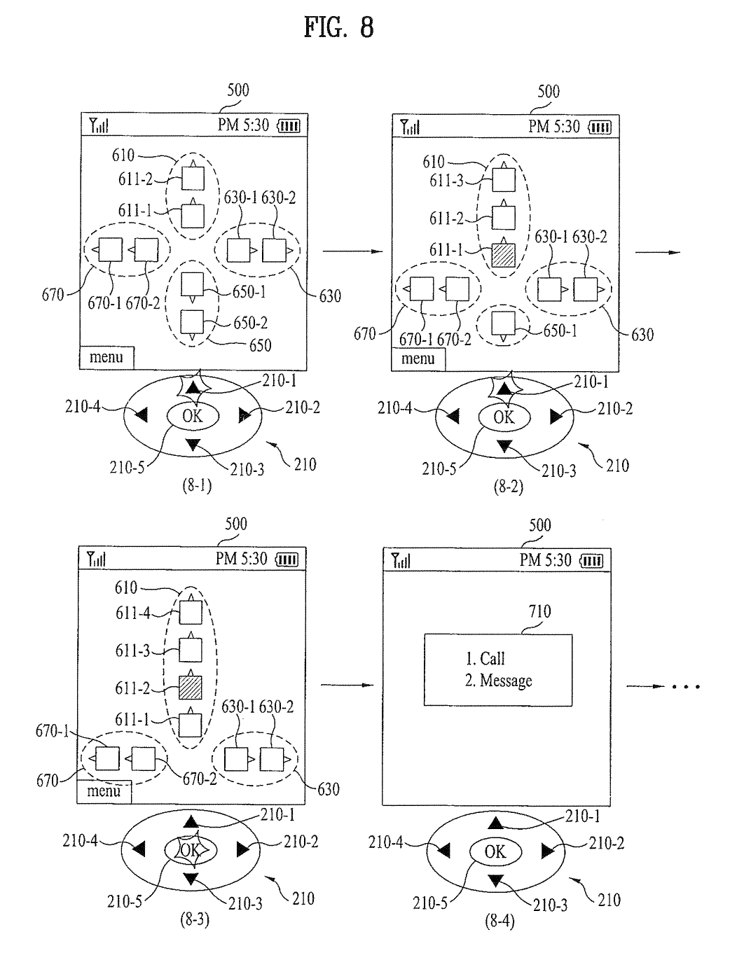

In an embodiment of the present invention in which the display 151 does not include a touchscreen, a method of controlling a mobile terminal 100 is explained with reference to FIG. 8. Referring to (8-1) of FIG. 8, objects are aligned on the real display screen 500 while the mobile terminal 100 is in a standby mode. It is to be understood that the objects are configured to be displayed if a prescribed menu manipulation is performed in the standby mode.

A navigation key 210, which is a part of the first user input unit for selecting one of the objects, is shown below the real display screen 500 in FIG. 8. Referring to (8-1) of FIG. 8, a first object category 610 displayed on the real display screen 500 is a phone number category. A method of selecting a phone number object 611-2 having a second highest priority in the phone number category 610 is explained as follows.

First, a terminal user selects an upper key 210-1 of the navigation key 210. Accordingly, an input signal corresponding to the selected upper key 210-1 is generated from the first user input unit 210 and then transferred to the controller 180. The controller 180 outputs a control signal corresponding to the selected upper key 210-1 to the display 151. Thus, the controller 180 controls all objects on the real display screen 500 to move downward by a prescribed distance, as shown in (8-2) of FIG. 8.

Therefore, an object 650-2, which was previously displayed on the real display screen 500 as in (8-1) of FIG. 8, disappears from the screen, as shown in (8-2) of FIG. 8. Further, an object 611-3, which was not previously displayed on the real display screen 500 in (8-1) of FIG. 8, is displayed on the screen, as shown in (8-2) of FIG. 8. Moreover, as shown in (8-2) of FIG. 8, a cursor indicating that an object 611-1 is selected that has a first priority in the first object category 610 is placed at the object 611-1.

Subsequently, the terminal user selects the upper key 210-1 of the navigation key 210 again. In response, an input signal corresponding to the re-selected upper key 210-1 is generated from the first user input unit 210 and then delivered to the controller 180 again. The controller 180 outputs a control signal corresponding to the re-selected upper key 210-1 to the display 151 and controls all the objects on the real display screen 500 to move downward by a prescribed distance once again, as shown in (8-3) of FIG. 8.

Therefore, an object 650-1, which was previously displayed on the real display screen 500 in (8-2) of FIG. 8, disappears from the screen, as shown in (8-3) of FIG. 8. Further, an object 611-4, which was not displayed on the real display screen 500 in (8-2) of FIG. 8 is newly displayed on the screen, as shown in (8-3) of FIG. 8. Moreover, in (8-3) of FIG. 8, a cursor indicating that an object 611-2 is selected that has a second priority in the first object category is placed at the object 611-2.

Subsequently, the terminal user selects an ‘OK’ key 210-5 or a confirmation key of the navigation key 210. In response, an input signal corresponding to the selected ‘OK’ key 210-5 is generated from the first user input unit 210 and then delivered to the controller 180. The controller 180 outputs a control signal corresponding to the selected ‘OK’ key 210-5 and displays a window 710 on the real display screen 500, as shown in (8-4) of FIG. 8. The window 710 is provided to query whether to make a phone call ‘1. Call’ or send a message ‘2. Message’ to a phone number corresponding to the object 611-2 having the second priority.

If the terminal user selects ‘1’ from key buttons of a second user input unit, the mobile terminal 100 attempts to make a phone call to the corresponding phone number. If the terminal user selects ‘2’ from key buttons of the second user input unit, a window (not shown in the drawing) for writing a message to the corresponding phone number is displayed.

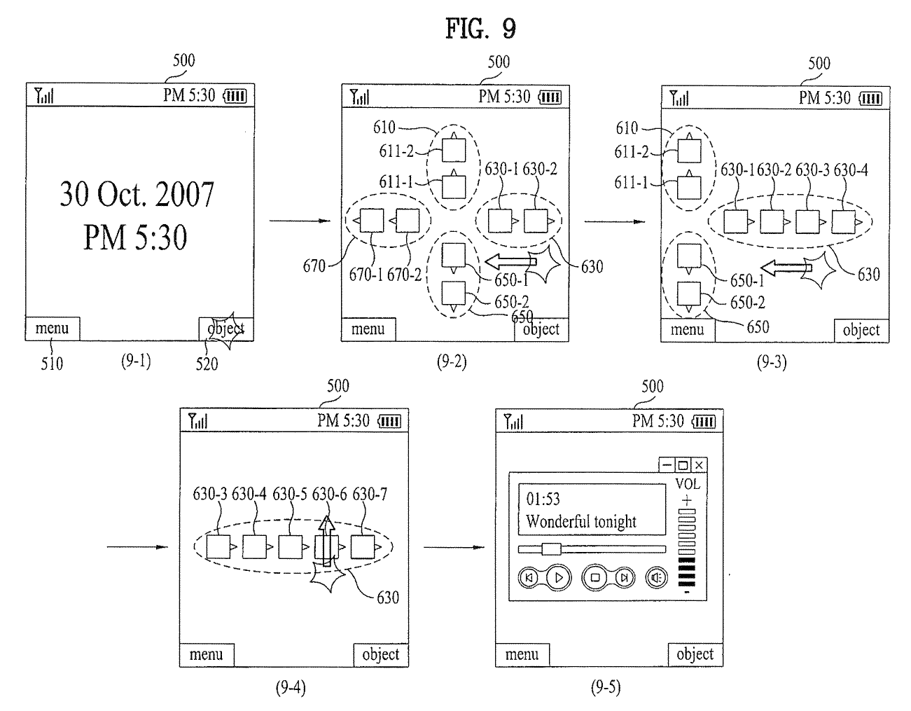

In an embodiment of the present invention in which the display 151 includes a touchscreen, a method of controlling a mobile terminal 100 is explained with reference to FIG. 9. The objects are displayed on the real display screen 500 in the standby mode of the mobile terminal 100. In the following description, the objects are displayed on the real display screen 500 if a request is made by a terminal user.

Referring to (9-1) of FIG. 9, a standby image indicating that the mobile terminal 100 is in a standby mode is displayed on the real display screen 500 of the mobile terminal. First, an ‘object’ icon 520 on the real display screen 500 is touched. In response, the touchscreen generates an input signal corresponding to the touched ‘object’ icon 520 and then transfers the generated input signal to the controller 180. The controller 180 outputs a control signal corresponding to the touched ‘object’ icon 520 to the touchscreen and then controls the objects to be displayed on the real display screen 500, as shown in (9-2) of FIG. 9.

Among four object categories 610, 630, 650, and 670 displayed on the real display screen 500 shown in (9-1) of FIG. 9, it is assumed that a second object category 630 having a pattern radiating in a rightward direction from a center of the screen in accordance with priority is an audio file category. As an example, a method of selecting a sixth priority audio file object 630-6 having a sixth highest priority in the audio file category 630 is explained as follows.

First, a prescribed point, preferably a point on which the objects are not aligned, is touched on the touchscreen by a terminal user. The touched point is dragged or flicked in a leftward direction opposite to the radiating direction of the second object category.

In response to dragging, an input signal is generated from the touchscreen and delivered to the controller 180. The controller 180 outputs a control signal corresponding to the dragging to the touchscreen and then controls the entire objects on the real display screen 500 to move in a leftward direction by a prescribed distance, as shown in (9-3) of FIG. 9. The movement of the objects is described above.

Subsequently, since the sixth priority audio file object 630-6 is not displayed on the real display screen 500 yet, a prescribed point, on which the objects are not aligned, is touched on the touchscreen again and then dragged or flicked in the leftward direction opposite to the radiating direction of the second object category. As mentioned above, the touchscreen and the controller 180 exchanges the corresponding input control signals with one another. Accordingly, all the objects on the real display screen 500 are controlled to move by a prescribed distance in the leftward direction again, as shown in (9-4) of FIG. 9.

Referring to (9-4) of FIG. 9, the sixth priority audio file object 630-6 is displayed on the real display screen 500. When the sixth priority audio file object 630-6 is selected and executed, the selection for the execution can be performed in various ways. In (9-4) of FIG. 9, the selection for the execution may be performed such that the sixth priority audio file object 630-6 is touched and flicked in a direction which is substantially vertical to the radiating direction and different from the radiating direction of the audio file category, for example, the upward or downward direction.

Accordingly, the sixth priority audio file object 630-6 is executed, as shown in (9-5) of FIG. 9. In the above described embodiments of the present invention, objects were categorized into four object categories, the four categories were aligned in a pattern radiating in four directions centering on a center of a display screen, and a specific object was selected and then executed. However, the present invention is not limited to the four object categories but is applicable aligning at least two categories in a pattern radiating in at least two directions.

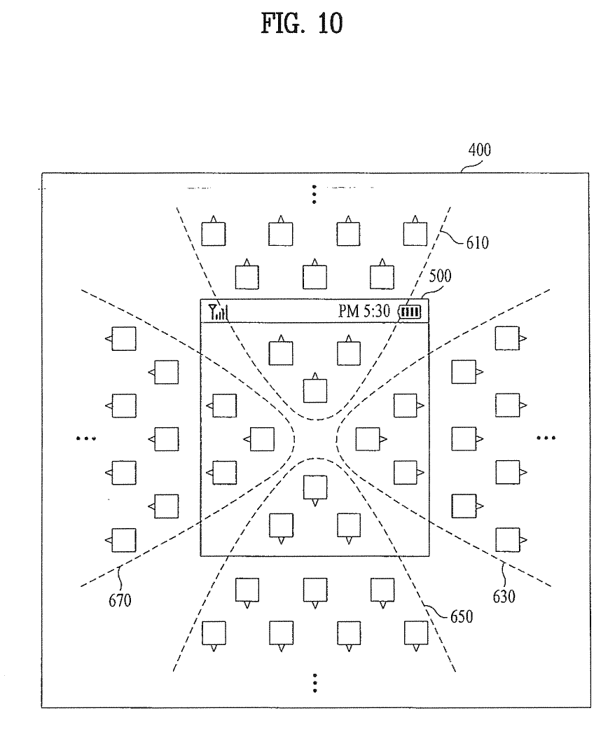

In the present invention, objects of each object category are not required to be aligned to radiate in a form of a single straight line. For example, at least two objects of each object category may be aligned to radiate in a form of at least two straight lines. Alternatively, objects of each object category may be aligned to radiate in a form of a group instead of a straight line, as shown in FIG. 10.

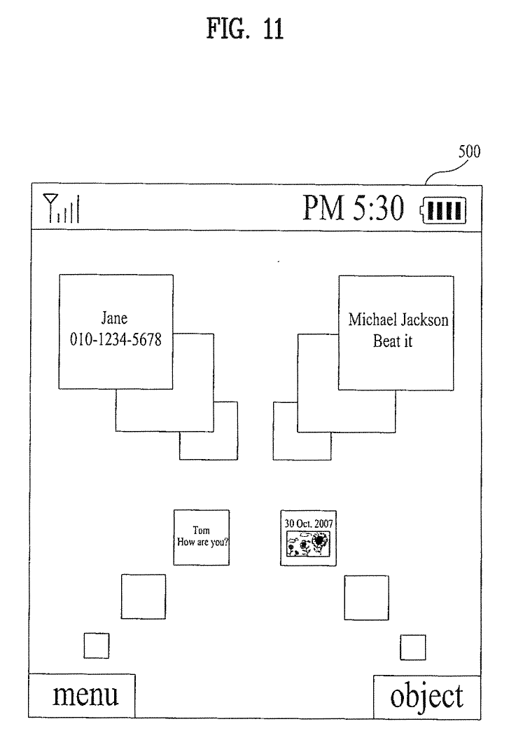

In the present invention, objects of each object category are not required to be aligned in a pattern of radiating on a single plane. For example, objects of each object category may be aligned in a pattern of radiating in a 3-dimensional space, as shown in FIG. 11.

As described above, the present invention allows a terminal user to conveniently select and execute a specific object since objects within a terminal are displayed in a predetermined pattern in accordance with priorities for each category.

The foregoing embodiments and advantages are merely exemplary and are not to be construed as limiting the present invention. The present teaching can be readily applied to other types of apparatuses and processes. The description of the present invention is intended to be illustrative, and not to limit the scope of the claims. Many alternatives, modifications, and variations will be apparent to those skilled in the art.

What is claimed is:

1. A terminal comprising:
a display unit;
a storage unit storing objects corresponding to at least one object category among a plurality of object categories; and
a control unit displaying one or more higher priority objects selected from a plurality of objects according to a priority of each of the plurality of object categories on a screen of the display unit.

2. The terminal of claim 1, wherein the control unit aligns the one or more higher priority objects in different directions according to corresponding categories to which the one or more higher priority objects belong.

3. The terminal of claim 2, wherein the control unit further displays the one or more higher priority objects such that figures of the one or more higher priority objects are visually distinguished from each other according to the corresponding categories.

4. The terminal of claim 3, wherein the control unit associates an appearance of the one or more higher priority objects with a direction of a category to which the one or more higher priority objects belong.

5. The terminal of claim 2, wherein the display unit comprises a touchscreen and the one or more higher priority objects belonging to a prescribed category are aligned on the touchscreen such that the control unit displays lower priority objects among the one or more higher priority objects on the touchscreen if the touchscreen is scrolled in a first direction.

6. The terminal of claim 5, wherein the control unit scrolls the touchscreen if the touchscreen is touched and flicked.

7. The terminal of claim 6, wherein the control unit executes a flicked object if the one or more higher priority objects belonging to the prescribed category on the touchscreen is flicked in a second direction substantially vertical to the first direction.

8. The terminal of claim 1, wherein the control unit associates a single object corresponding to at least two object categories with only one of the at least two object categories.

9. The terminal of claim 1, wherein the plurality of object categories comprise at least one of a recent call number category, a recent stored number category, a recently absent number category, a most frequently call number category, a recent message category, a recently executed multimedia contents category, a most frequently executed multimedia contents category or a recently stored multimedia contents category.

10. The terminal of claim 2, wherein the control unit aligns the one or more higher priority objects in a 3-dimensional space.

11. The terminal of claim 1, wherein the control unit aligns the one or more higher priority objects belonging to the object categories in specific directions associated with corresponding object categories.

12. The terminal of claim 11, wherein the control unit locates the one or more higher priority objects belonging to the corresponding at least one object category at a central part of the screen of the display unit and the control unit locates the one or more objects in a peripheral part of the screen of the display unit if priorities of the one or more objects become lower.

13. A method of controlling a terminal, the method comprising:
storing objects corresponding to at least one of a plurality of object categories; and
displaying at least one of a plurality of objects according to a priority of each of the plurality of object categories such that one or more higher priority objects are displayed on a display screen of the terminal.

14. The method of claim 13, wherein the plurality of object categories comprise at least one of a recent call number category, a recent stored number category, a recently absent number category, a most frequently call number category, a recent message category, a recently executed multimedia contents category, a most frequently executed multimedia contents category or a recently stored multimedia contents category.

15. The method of claim 13, wherein the at least one higher priority objects are aligned in different directions according to corresponding object categories to which the at least one higher priority objects belong.

16. The method of claim 13, wherein the at least one higher priority objects are aligned in a 3-dimensional space.

17. The method of claim 13, wherein the at least one higher priority objects belonging to a plurality of corresponding object categories are aligned in specific directions associated with the plurality of corresponding object categories.

18. A recording medium comprising a recorded program, the program executing a method of controlling a terminal, the method comprising:
storing objects corresponding to at least one of a plurality of object categories; and
displaying at least one or more of a plurality of the objects according to a priority for each of the plurality of object categories such that at least one higher priority objects displayed on a display screen of the terminal.

19. The recording medium of claim 18, wherein the plurality of object categories comprises at least one of a recent call number category, a recent stored number category, a recently absent number category, a most frequently call number category, a recent message category, a recently executed multimedia contents category, a most frequently executed multimedia contents category or a recently stored multimedia contents category.
